(19) United States
(12) Patent Application Publication
(10) Pub. No.: US 2026/0336479 A1
(43) Pub. Date: Oct. 29, 2026

(54) RAIL ASSEMBLY HAVING A COVERING DEVICE

(71) Applicant: Adient US LLC, Plymouth, MI (US)

(72) Inventors: Erik SPRENGER, Wermelskirchen (DE); Thomas MAYER, Radevormwald (DE); Arne MATTHES, Burscheid (DE)

(73) Assignee: Adient US LLC, Plymouth, MI (US)

(21) Appl. No.: 19/660,370

(22) Filed: Apr. 28, 2026

(30) Foreign Application Priority Data
Apr. 29, 2025 (DE) 102025116420.7

(51) Int. Cl. B60N 2/07

(52) U.S. Cl. CPC B60N 2/0725; B60N 2/0715

(57) ABSTRACT

A rail assembly for a longitudinal adjuster of a vehicle seat may have one first rail, one second rail, which is arranged movably relative to the first rail, and one covering device for covering a rail opening in the first rail. The covering device may have at least one covering element, which is arranged at one rail end of the first rail in such a way that it can be rolled up, and one adapter, which is arranged between the second rail and the covering element and is configured to compensate length tolerances during assembly.

### FIELD

The invention relates to a rail assembly having a covering device for covering the rail opening.

### BACKGROUND

DE 10 2016 224 588 A1 discloses a longitudinal adjuster having a rail subassembly comprising a lower rail and an upper rail, which is movably connected to the lower rail. Also disclosed is a cover (e.g. a rubber cover, a brush-type cover etc.), which is connected to an outer profile of the lower rail and is arranged in such a way that it covers at least part of an inner profile. The cover can comprise a rubber strip which is connected to the outer profile and is arranged on an upper part of each side of the inner profile. The cover can extend generally parallel to a longitudinal axis of the inner profile. The cover covers at least part of the corresponding interspaces of the lower rail. The cover serves to restrict/prevent the ingress or falling of dirt and/or fabric into corresponding interspaces of the lower rail.

The problem addressed by the invention is that of specifying a rail assembly having an improved covering device for covering a rail opening, in particular to provide a robust covering device that is easy to install and prevents the ingress of dirt particles or other disruptive elements into the rail opening.

According to the invention, this problem is solved by means of a rail assembly having the specified features in claim 1.

### SUMMARY

Advantageous embodiments, which can be used individually or in combination with one another, form the subject matter of the dependent claims.

The rail assembly according to the invention for a longitudinal adjuster of a vehicle seat comprises at least one first rail, one second rail, which is arranged movably relative to the first rail, and one covering device for covering a rail opening in the first rail, wherein the covering device comprises at least one covering element, which is arranged at one rail end of the first rail in such a way that it can be rolled up, and one adapter, which is arranged between the second rail and the covering element and is configured to compensate length tolerances during assembly.

The adapter is a compensating adapter or a length adapter, for example. For example, the adapter is configured to compensate length tolerances between the rails and/or between one of the rails and the covering element during assembly.

The advantages achieved by means of the invention consist in that such a covering device, in particular the covering device having such an adapter, always enables and ensures connection of the covering element to the rail, irrespective of dimensional deviations that arise during production of individual components of the rail assembly. The covering device can be provided and installed in a simple manner. Moreover, the covering device is of space-saving and compact design. The covering device is designed with a reduced number of parts.

The adapter enables automatic coupling of the covering element to the second rail during adjustment, in particular longitudinal adjustment, of the second rail into an end position of the adjustment range thereof. When the second rail is adjusted into a possible end position for the first time, the adapter comes into automatic engagement with the covering element. Owing to tolerances, in particular length tolerances, in the rail system, the adjustment travel may differ. The adapter is provided to produce a connection between the covering element and the second rail, whatever the tolerances.

The adapter can be configured to connect one rail end of the second rail and a free first covering end of the covering element to one another via at least one latching connection, irrespective of length tolerances.

The latching connection can be of releasable configuration. It is thereby possible to simplify exchange, maintenance and what is referred to as an "end of the line" check. The releasable latching connection also enables the coupling between the second rail and the covering element to be separated easily and quickly in the case of servicing in the vehicle.

In an assembled state, the covering element can be latchable or latched to the adapter in stages. Latching in stages can be similar to a latching function of a cable tie. Engagement is greater or less, depending on the tolerance, in particular length tolerance. In all cases, however, secure connection occurs.

The adapter can have a first latching element or a plurality of first latching elements, which are spaced apart from one another in a longitudinal extent of the adapter.

The first latching elements of the adapter can each be designed as latching teeth, latching steps and/or offsets.

The adapter can have at least one second latching element, which is designed as a latching knob.

The covering element can have at its free first covering end at least one first counter latching element. In an initial state and in an unassembled state, the first counter latching element can be guided at least partially out of the rail opening and project upward. In a latching position, the first counter latching element of the covering element can engage behind or below a first latching element of the adapter, e.g. a latching tooth and/or a latching step. In the latching position, the first counter latching element of the covering element can be accommodated in a gap between two first latching elements or in a latching recess and can latch on a stop surface of the first latching element.

The first counter latching element of the covering element can be of elastically movable design. The first counter latching element can be of flexible design. The first counter latching element can be designed as a latching tongue or latching tab which projects and is raised, in particular punched out, at the free first covering end. The first counter latching element can be prestressed. The first counter latching element can be raised by being punched out of a surface of the free first covering end, for example.

The first counter latching element can be in the form of a clamp, e.g. a spring clamp. The first counter latching element can be of L-shaped or V-shaped design, for example. The first counter latching element can be raised in the form of a latching hook.

During assembly, the first counter latching element can be moved, in particular pressed, downward counter to its spring force and/or prestress. During longitudinal adjustment of the second rail into one of its end positions, the adapter comes into contact with the first counter latching element and can press this downward counter to its spring force and/or prestress. The adapter can "override" the covering end having the first counter latching element. When it reaches an end position of the second rail, the first counter latching element can latch on a first latching element of the adapter in a self-acting way. Owing to its spring force, the first counter latching element can be designed as a tab and/or tongue that can be latched in a self-acting way. In order to produce a connection between the first counter latching element and the adapter, whatever the tolerances, the adapter has at least one first latching element and/or a stepped latching contour.

A plurality of first latching elements can form a latching contour with a plurality of latching gaps in the longitudinal direction. The engagement is greater or less, depending on the tolerances, but in all cases a secure connection, in particular a latching connection, occurs. In an assembled state, the first counter latching element of the covering element can be latchable or latched in stages, e.g. selectively, on one of the first latching elements of the adapter.

The covering element can have at its free first covering end at least one second counter latching element. The second counter latching element can be designed as a latching opening. The second counter latching element can be a punched hole. The second latching element, e.g. in the form of a latching knob of the adapter, can enter into a latching connection with the second counter latching element, e.g. in the form of a latching opening in the covering element. In a latching position, the second latching element can latch on the second counter latching element of the covering element. The latching knob of the adapter can engage in the latching opening in the covering element. Alternatively or optionally in addition, the adapter can have at least one latching opening and the covering element can have at least one latching knob.

Depending on the tolerance, the first counter latching element is over-bent or can have a play. In either case, the second latching element of the adapter enters into latching engagement with the second counter latching element of the covering element. In all cases, therefore, secure connection occurs.

The adapter is designed for automatic coupling of the covering element to the second rail during adjustment of the second rail into the end positions of the adjustment range thereof.

The adapter can have an adapter body, e.g. a carrier body and/or a carrier profile. The adapter can have at least two adapter arms arranged on the adapter body and oriented in the vertical direction with respect to one another. In assembled state, the covering element, in particular the free first covering end, can be arranged partially between the adapter arms. The free first covering end, which has the first counter latching element, can be accommodated, e.g. clamped, between the adapter arms when the first counter latching element is latched on a first latching element of the adapter.

An upper adapter arm can have a first latching element or a plurality of first latching elements on an inner side facing the first counter latching element of the covering element.

In the region of the first latching element or first latching elements, the upper adapter arm can have an engagement opening for the release of the first counter latching element of the covering element from its latching position. The latching connection can be of releasable configuration.

The adapter can have at least one engagement opening in order to be able to press on the first counter latching element of the covering element for disassembly. The latching engagement or latching connection can be released by pressure on the first counter latching element. The covering element can roll up again. It is thereby possible to simplify exchange, maintenance and what is referred to as an "end of the line" check. The releasable latching connection also enables the latching between the first counter latching element and the first latching element to be separated easily and quickly in the case of servicing in the vehicle.

The upper adapter arm can be designed in such a way that a first counter latching element formed by punching and flaring is coverable or covered at one surface of the free first covering end of the covering element. By means of the adapter arm, an opening in the region of the raised and projecting first counter latching element is coverable or covered. This improves shielding of rail elements, e.g. a spindle, arranged in the rail profile of the first rail, from dirt.

The upper adapter arm can, for example, comprise a first adapter nose having the first latching element or the first latching elements. In each case laterally with respect to the first adapter nose, the upper adapter arm can comprise a second adapter nose. For example, the second adapter nose can be provided with the second latching element, e.g. a latching knob. The first adapter nose can have a suitable length and width for covering the opening in the region of the first counter latching element of the covering element.

On an inner side facing the first counter latching element of the covering element, a lower adapter arm can have a supporting contour, which is designed to interact with the upper adapter arm during the insertion of the first counter latching element and to make the covering element, in particular the free first covering end, form an arch, in particular a transverse arch.

The adapter can be designed as a plastic adapter and/or plastic clip which can be detachably or non-detachably connectable or connected to the second rail. The use of a plastic adapter, in particular a plastic clip, avoids creaking noises in the interface. It is thereby possible to avoid steel-to-steel contact as in conventional covering devices. In the case of relative movements, steel-to-steel contact can lead to troublesome noises while driving. An adapter formed from plastic has the advantage that troublesome noises, such as creaking noises and/or scratching noises, can be reduced or even avoided during the operation of a rail assembly.

The free first covering end of the covering element, which is designed as a rolling spring for example, can be of flat design in the transverse direction. As the covering element is pulled out, a region adjacent to the free first covering end, which was previously in the rolled-up state, has a transverse arch. In the case of rolling springs, this may be due to the design thereof. The covering element, which, before the installation of the second rail, is arranged rolled up in the covering device, can have a continuous arched surface. In the region of the transition from the straight first covering end to the rolled-up or wound-up region, waviness may occur. This waviness can increase friction in a guide channel, e.g. a bezel, for guiding the covering element during rail adjustment. As the rolling spring is inserted into the adapter, the first covering end of the rolling spring may be arched in the transverse direction in order to match the transition to the transverse arch of the remainder of the rolling spring. It is thereby possible to reduce the waviness in the region of the transition. The friction in the guide channel can be correspondingly reduced.

The covering device can have a bezel with a bezel opening, wherein the covering device is arranged on the first rail in such a way that the rail opening in the first rail and the bezel opening are one above the other. The bezel opening can be at least partially closable by means of the roll-up covering element guided in a guide channel of the bezel. In a delivery position, or supply position, the raised first counter latching element can be guided out of the bezel opening. For example, the first counter latching element can engage around the bezel at a bezel edge of the bezel opening in an initial state and/or a delivery position. In this state and/or this position, floor attachment regions, e.g. for screws, can be accessible for a person, and the first rail can be screwed to the vehicle floor.

A first latching connection can be produced by the latching of the first counter latching element of the covering element and of the first latching element of the adapter. An optional or additional second latching connection can be produced by the latching of the second counter latching element of the covering element and of the second latching element of the adapter. If the second rail is adjusted after the production of at least one latching connection, e.g. after the docking of the rolling spring, the rolling spring is extended and covers the rail opening and the bezel opening in the bezel. Floor screw fastenings and the spindle of the longitudinal adjuster can thereby be covered.

The covering device can comprise at least one cassette and a covering element that is accommodated and can be rolled up in the cassette. A first covering end of the covering element, which can be guided or is guided out of the cassette, can have the first counter latching element and the second counter latching element. The first covering end of the covering element, which can be guided or is guided out, can be connectable or connected to the adapter provided on the second rail. The cassette can be in the form of a housing, e.g. a plastic housing and/or metal housing.

The covering element is connectable or couplable to the second rail during assembly, i.e. before final assembly. After assembly, the covering element is releasably connected or coupled via the adapter to the second rail, for example. In a stowed state of the covering element, it is accommodated fully in the cassette. When the second rail moves in a direction away from the cassette, the covering element can be guided, in particular pulled, further out of the cassette in order to partially close, in particular cover, the rail opening in the first rail.

The cassette can be positioned in a space-saving manner at one end of the first rail or of the rail assembly. The cassette can have an opening, in particular a housing opening, for example, through which the first covering end can be guidable or guided in a simple and uncomplicated manner.

The covering element can be designed as a prestressed rolling spring. The covering element can be designed as a spring element that can be rolled in a self-acting way. A spring force of the covering element brings about rolling in, for example. By moving the second rail in a direction counter to the spring force, in particular in a direction away from the cassette, the covering element can be pulled out, in particular unrolled. The covering element can be prestressed. For example, the covering element can be arranged in such a way that it rolls itself in and out within the cassette. The covering element can be designed as some other element that can be rolled up and rolled in.

By virtue of the fact that the covering device has a bezel with a bezel opening and the bezel opening is at least partially closable by means of a roll-up covering element guided in a guide channel of the bezel, variable covering of a rail opening arrangeable or arranged underneath the bezel can be ensured. By virtue of the fact that the covering element is guided in a guide channel of the bezel, lateral closure of the bezel opening of the bezel and the possibility of imposing a load on the covering element from above are ensured. In particular, this ensures that no dirt particles or other disruptive elements push through the covering.

The invention proceeds from the consideration that, during installation of the rail assembly in the vehicle, in particular on a vehicle floor, the covering device must be opened to gain access to fastening points in the first rail, in particular in the bottom rail, for fastening to the vehicle floor, wherein the covering element must be pulled up manually after the bottom rail has been fastened on the vehicle floor. During this process, damage may occur both to the guide channel and to the covering element.

In particular, the adapter provides an interface, and this can enable self-acting or automatic coupling, in particular latching connection. This self-acting latching connection is implemented without tools. Thus, particularly simple assembly is made possible. In addition, damage to the guide track is avoided. Moreover, such an adapter is of short construction.

### DESCRIPTION OF THE FIGURES

The invention is explained in greater detail below by means of advantageous exemplary embodiments illustrated in the figures. However, the invention is not restricted to these exemplary embodiments. In the drawing:

FIG. 1: shows a vehicle seat having a longitudinal adjuster in schematic illustration,

FIG. 2: shows a plan view of a segment of a covering device according to a first exemplary embodiment according to the invention, wherein the covering device is mounted on a fixed rail of a longitudinal adjuster ready for mounting on a vehicle,

FIG. 3: shows a longitudinal section through a segment of the covering device in the region of a cassette for a covering element of the covering device according to a first exemplary embodiment according to the invention,

FIG. 4: shows a longitudinal section through a segment of the covering device in the region of an adapter for connecting the covering element to the second rail according to a first exemplary embodiment according to the invention,

FIG. 5: shows a longitudinal section through a segment of the covering device in a first assembly position according to a first exemplary embodiment according to the invention,

FIG. 6: shows a longitudinal section through a segment of the covering device in a second assembly position according to a first exemplary embodiment according to the invention,

FIG. 7: shows a longitudinal section through a segment of a rail assembly with a mounted covering device according to a first exemplary embodiment according to the invention,

FIG. 8: shows an enlarged detail of the mounted covering device according to a first exemplary embodiment according to the invention,

FIG. 9: shows a plan view of a segment of the mounted covering device according to a first exemplary embodiment according to the invention,

FIG. 10: shows a cross section through a rail assembly with a mounted covering device according to a first exemplary embodiment according to the invention,

FIG. 11: shows a plan view of a segment of a second rail of a rail assembly before the installation of an adapter of a covering device according to a first exemplary embodiment according to the invention,

FIG. 12: shows a plan view of a segment of a covering device according to a second exemplary embodiment according to the invention,

FIG. 13: shows a longitudinal section through a segment of the covering device in the region of an adapter for connecting the covering element to the second rail according to a second exemplary embodiment according to the invention,

FIG. 14: shows a longitudinal section through a segment of the covering device in a first assembly position according to a second exemplary embodiment according to the invention,

FIG. 15: shows a longitudinal section through a segment of the covering device in a second assembly position according to a second exemplary embodiment according to the invention,

FIG. 16: shows another longitudinal section through a segment of the covering device in the second assembly position according to FIG. 15,

FIG. 17: shows a longitudinal section through a segment of the covering device in a third assembly position according to a second exemplary embodiment according to the invention,

FIG. 18: shows a cross section through a rail assembly with a mounted covering device according to a second exemplary embodiment according to the invention,

FIG. 19: shows a plan view of a segment of a second rail of a rail assembly before the installation of an adapter of a covering device according to a second exemplary embodiment according to the invention,

FIG. 20: shows a plan view of a rail assembly arranged on a vehicle floor and comprising a fixed rail, a movable rail, which has been adjusted to a forward longitudinal position, and a pre-installed covering device, wherein a rail opening for screwing the fixed rail to the vehicle floor is disclosed,

FIG. 21: shows a longitudinal section through the rail assembly according to FIG. 20,

FIG. 22: shows a longitudinal section through the rail assembly, wherein the movable rail has been adjusted to one of its end positions for connecting an adapter to a covering element of the covering device,

FIG. 23: shows a longitudinal section through the rail assembly, wherein, after the connection of the adapter to the covering element of the covering device, the movable rail has been adjusted to a forward longitudinal position, and

FIG. 24: shows a plan view of the rail assembly, wherein a rail opening is covered by the covering element connected to the adapter.

### DETAILED DESCRIPTION

Parts that correspond to one another are provided with the same reference signs in all the figures.

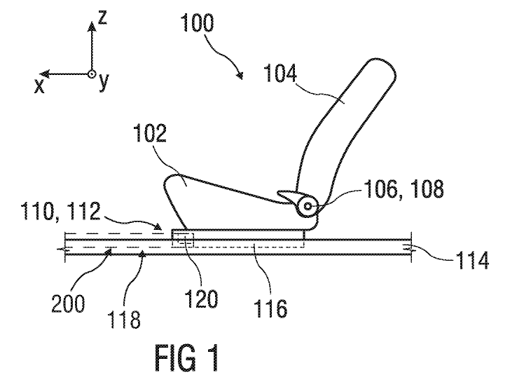

A vehicle seat 100 illustrated schematically in FIG. 1, relating to the prior art, is described below using three spatial directions running perpendicular to one another. With a vehicle seat 100 installed in the vehicle, a longitudinal direction x runs largely horizontally and preferably parallel to a vehicle longitudinal direction, which corresponds to the usual direction of travel of the vehicle. In the vehicle, a transverse direction y running perpendicularly to the longitudinal direction x is likewise aligned horizontally and runs parallel to a vehicle transverse direction. A vertical direction z runs perpendicularly to the longitudinal direction x and perpendicularly to the transverse direction y. With a vehicle seat 100 installed in the vehicle, the vertical direction z preferably runs parallel to a vehicle vertical axis.

The position indications and direction indications used, e.g. front, rear, up and down refer to a direction of view of an occupant sitting in the vehicle seat 100 in a normal sitting position, wherein the vehicle seat 100 is installed in the vehicle and aligned in a position of use suitable for carrying people, with the seat back 104 upright, and as normal in the direction of travel. However, the vehicle seat 100 can also be installed or moved in a different orientation, e.g. transversely to the direction of travel. Unless described otherwise, the vehicle seat 100 is constructed in mirror symmetry with a plane running perpendicularly to the transverse direction y.

The seat back 104 can be arranged pivotably on a seat part 102 of the vehicle seat 100. For this purpose, the vehicle seat 100 can optionally comprise a fitting 106, in particular an adjustment fitting, rotation fitting, latching fitting or tilt fitting.

The position indications and direction indications used, such as radial, axial and in the circumferential direction, refer to an axis of rotation 108 of the fitting 106. Radial means perpendicular to the axis of rotation 108. Axial means in the direction of or parallel to the axis of rotation 108.

The vehicle seat 100 can optionally comprise a longitudinal adjuster 110. The longitudinal adjuster 110 comprises, for example, a rail assembly 112 having a first rail 114 and a second rail 116. The second rail 116 is adjustable relative to the first rail 114 in the longitudinal direction x. The second rail 116 is secured on the seat part 102. The first rail 114 is secured on a structural element of a vehicle, e.g. a vehicle floor.

The first rail 114 is referred to as the bottom rail or fixed rail in the following description. The bottom rail is connected in a fixed manner and by way of example to the floor of a vehicle. The second rail 116 is referred to as the top rail (also referred to as the running rail or slide) in the following description. The top rail is assigned to the vehicle seat 100 and configured to support this vehicle seat 100.

A covering device 200 is provided to cover open regions of the first rail 114.

The rail assembly 112 comprises at least the first rail 114, the second rail 116, which is arranged movably relative to the first rail 114, and the covering device 200 for covering a rail opening 118 in the first rail 114.

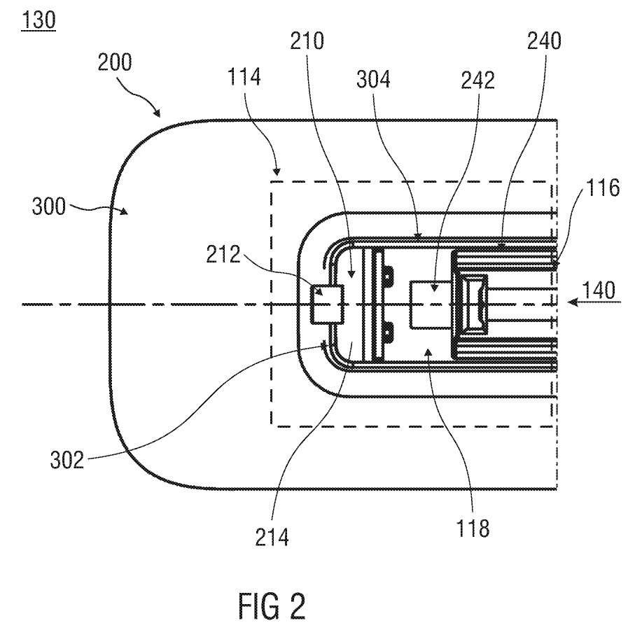

FIG. 2 shows a plan view of a segment of a covering device 200, wherein the covering device 200 is pre-installed on a fixed rail 114 of a longitudinal adjuster 110 and is prepared for mounting on or in a vehicle.

The covering device 200 comprises at least one covering element 210, which covers a region of a rail opening 118 in the first rail 114 which is not covered by the second rail 116. For this purpose, the covering element 210 is designed as a roll-up element in order to cover the first rail 114, in particular the rail opening 118 thereof, in a correspondingly variable manner during a movement of the second rail 116 relative to the first rail 114.

In particular, FIG. 2 shows the covering element 210, e.g. in the form of a rolling spring, having at least one first counter latching element 212, e.g. in the form of a raised and punched-out tab and/or tongue, in a delivery position 130. The first counter latching element 212 is supported on an upper side of a bezel edge 302 of a bezel 300. In a delivery position 130, the raised first counter latching element 212 can be guided out of the rail opening 118 and out of a bezel opening 304 of the bezel 300 for simplified docking. For example, the first counter latching element 212 can engage around the bezel 300 at a bezel edge 302 of the bezel opening 304 in an initial state and/or a delivery position 130. In this state and/or this position, floor attachment regions can be accessible for a person in order to screw the first rail 114 to a vehicle floor.

The second rail 116 can have a relatively long adjustment travel. Owing to the long adjustment travel, a spindle 120 (shown in FIG. 8) cannot be covered by the rail profile of the second rail 116 over the entire adjustment range thereof. This can lead to soiling of the spindle 120 and can potentially lead to a malfunction. To avoid this, the covering element 210, in particular a constant force spring, e.g. a rolling spring or roll-up leaf spring, covers the gap or the rail opening 118 in the first rail 114 and the bezel opening 304 in the bezel 300.

During the installation of the first rail 114 in the vehicle, the covering device 200, in particular the covering element 210, must be opened, in particular rolled up, in order to have access to screw-on points for fastening means in the vehicle floor.

To simplify installation, the first counter latching element 212 of the covering element 210 can be in contact with the bezel 300, in particular with a cutout in the bezel 300. The covering element 210 can thereby be held in position for installation.

The first rail 114, in particular a lower rail, comprises a bezel 300 in the direction of the second rail 116. The bezel 300 is designed as a bezel frame which runs around the, in particular elongate or slotted, rail opening 118 in the first rail 114. The bezel 300 lies above or on the first rail 114. As a result, the bezel 300 is supported on the first rail 114. In addition, the bezel 300 can also cover side regions of the first rail 114.

The bezel 300 can be a plastic element, in particular a plastic bezel. In particular, the first rail 114 is designed as a profile component, in particular a metal profile component.

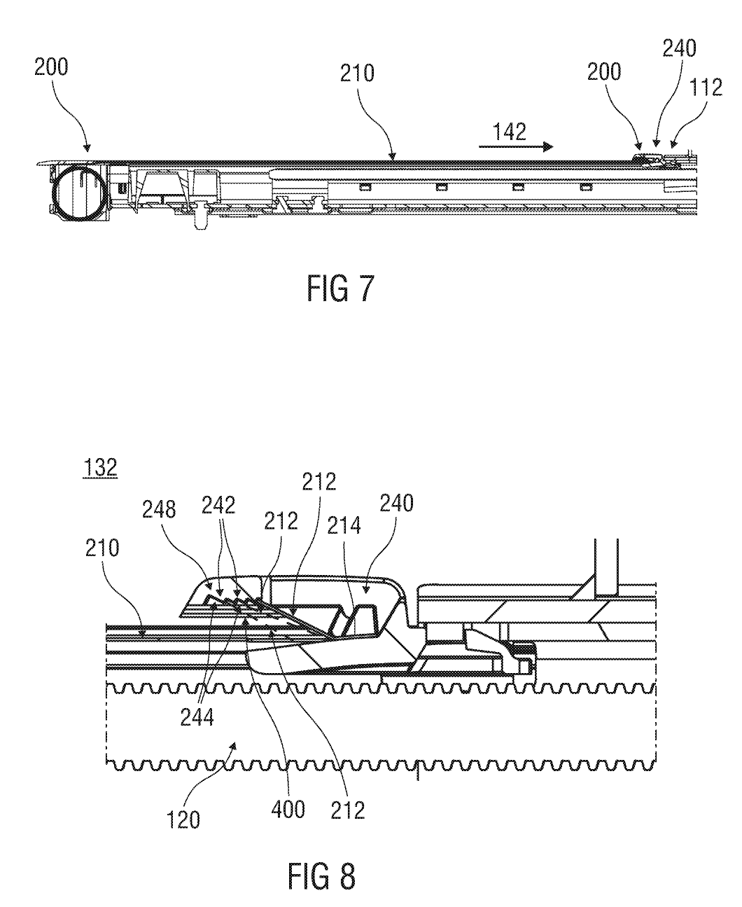

To cover the rail opening 118 and the bezel opening 304, the covering device 200 comprises the covering element 210, which is shown in the unrolled state in FIG. 7 and thus in a state in which it covers the rail opening 118 and the bezel opening 304. The bezel 300 can have an outwardly projecting collar region for covering the vehicle floor, e.g. for clamping and/or holding down a carpet.

An embodiment without a bezel is also possible.

At least the rail opening 118 can be partially closable by means of the covering element 210 guided in the bezel 300. By means of the at least partial covering of the rail opening 118 by means of the covering element 210, it is possible, for example, to block the view of a spindle 120 (illustrated in FIG. 8), arranged within a first rail 114, of an electric adjustment system.

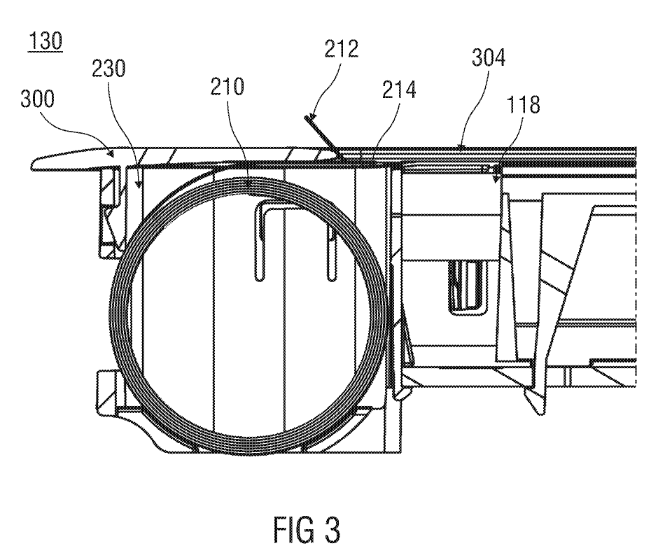

At its rear end, the covering device 200 can have a first cassette 230 (shown in FIG. 3). At a front end, the covering device 200 can have a second cassette 230. The covering device 200 preferably has a first cassette 230 at a rear end and a second cassette 230 at a front end. The covering element 210 for covering a first region in front of the second rail 116 (in the longitudinal direction) can be provided in the first cassette 230. A second covering element 210 for covering a second region behind the second rail 116 (in the longitudinal direction) can be provided in the second cassette 230. The covering element 210 can be rolled up in the respective cassette 230.

The covering element 210 can be of spring-elastic design. The covering element 210 can be a constant force spring, in particular a rolling spring. A first end, that is to say a free first covering end 214 of the covering element 210 can be connected or can have been connected to a second rail 116. A second end of the covering element 210 can be arranged in a captive manner in the cassette 230 assigned to the covering element 210 or in a housing. In particular, the covering element 210 is supported in a captive manner in the cassette 230 in the rolled-up state and when being unrolled or rolled up. For this purpose, the covering element 210 has a length, and/or the cassette 230 has a shape and/or dimensions, at least on the inside, such that the covering element 210 can be arranged in the cassette 230 when rolled up and, while the free first covering end 214 of the covering element 210 is being subjected to a force, in particular a pulling force, for unrolling, or while the covering element 210 is being subjected to a force, in particular a restoring force, for rolling up the covering element 210 again, this element is arranged, in particular supported, in a captive manner in the cassette 230.

The covering device 200 furthermore comprises an adapter 240 arranged on the second rail 116. The adapter 240 is arranged between the second rail 116 and the covering element 210 and is configured to compensate length tolerances during assembly.

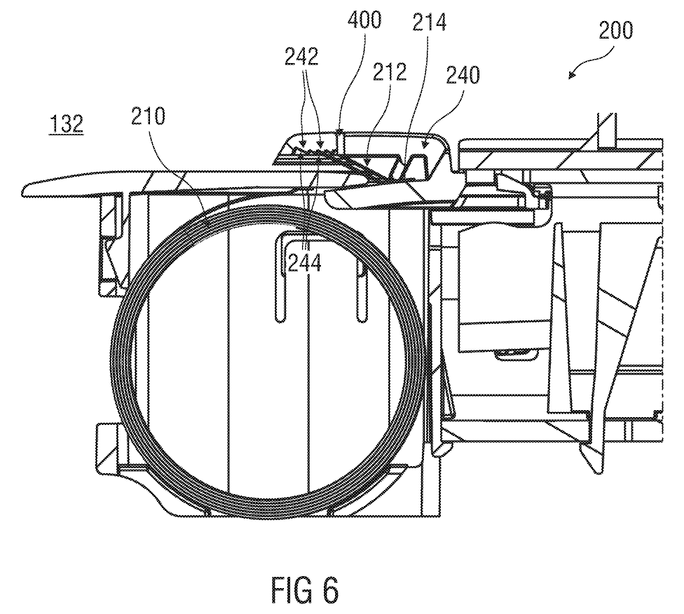

The adapter 240 is configured to connect one rail end of the second rail 116 facing the covering element 210 and a free first covering end 214 of the covering element 210 to one another via at least one first latching connection 400 (in FIG. 6), irrespective of length tolerances. The adapter 240 comprises at least one first latching element 242 corresponding to the first counter latching element 212 of the covering element 210.

The first covering end 214 projects into the rail opening 118 in the longitudinal extent of the first rail 114 and can be held in position by the first counter latching element 212 of the covering element 210 in order to be coupled to the adapter 240.

The covering device 200 comprises the covering element 210, which is pre-installed on the fixed first rail 114. The first rail 114 can be pre-installed on the vehicle by means of screws. The covering device 200 comprises the adapter 240, which is pre-installed on the movable second rail 116. The second rail 116 can be pre-installed movably on the first rail 114. For automatic installation of the covering device 200 and the adapter 240, the movable second rail 116 is moved in the direction of the covering element 210, in particular in the direction of the first covering end 214 of the covering element 210, in accordance with arrow 140.

FIG. 3 shows a longitudinal section through a segment of the covering device 200 in the region of a cassette 230 for a covering element 210 of the covering device 200.

The rail opening 118 in the first rail 114 and the bezel opening 304 are one above the other.

The covering element 200 can have at its free first covering end 214 at least one first counter latching element 212. In an initial state and in an unassembled state, the first counter latching element 212 can be guided at least partially out of the rail opening 118 and the bezel opening 304 and project upward.

In a delivery position 130, the raised first counter latching element 212 can be in contact with the bezel opening 304 in the bezel 300. For example, the first counter latching element 212 can engage around the bezel 300 on an inner side of the bezel opening 304 in an initial state and/or a delivery position 130. The free first covering end 214 can thereby be held in position. In this state and/or this position, floor attachment regions, e.g. for screws, can be accessible for a person, and the first rail 114 can be screwed to the vehicle floor.

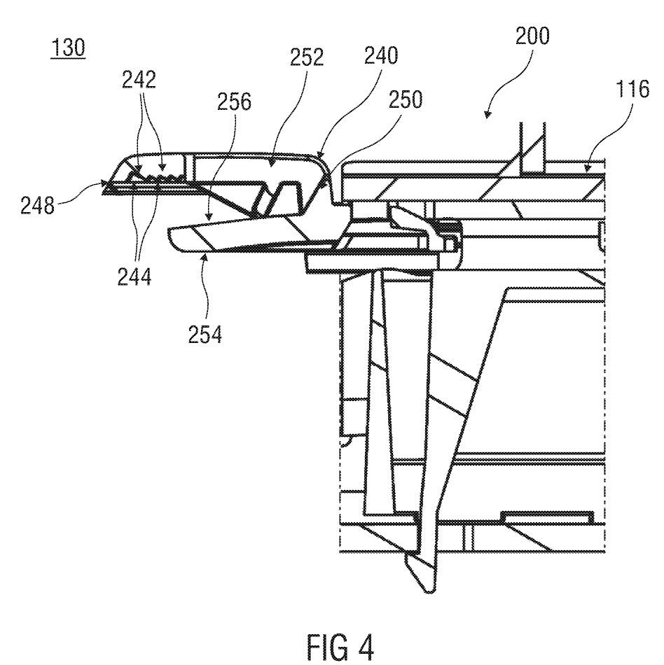

FIG. 4 shows a longitudinal section through a segment of the covering device 200 in the region of an adapter 240 for connecting the covering element 210 to the second rail 116.

A plurality of first latching elements 242 can form a latching contour 248 with a plurality of latching gaps 244 in the longitudinal direction x. The engagement is greater or less, depending on the tolerances, but in all cases a secure connection, in particular a latching connection 400, occurs. In an assembled state 132 (as shown in FIGS. 6 and 8), the first counter latching element 212 of the covering element 210 can be latchable or latched in stages, e.g. selectively, on one of the first latching elements 242 of the adapter 240. The first counter latching element 212 of the covering element 210 can latch in stages in the respective latching gap 244, e.g. depending on different length tolerances. It is thereby possible to provide a covering device 200 for rail assemblies 112 to be installed, which may each have different length tolerances.

The adapter 240 comprises an adapter body 250 and at least two adapter arms 252, 254 arranged on the adapter body 250 and spaced apart or oriented in the vertical direction z relative to one another, wherein the covering element 210 is arranged partially between the adapter arms 252, 254 in an assembled state 132.

The free first covering end 214, which has the first counter latching element 212, can be accommodated, e.g. clamped, between the adapter arms 252, 254 when the first counter latching element 212 is latched on a first latching element 242 of the adapter 240.

The upper adapter arm 252 comprises a plurality of first latching elements 242 on an inner side facing the first counter latching element 212 of the covering element 210.

On an inner side facing the first counter latching element 212 of the covering element 210, the lower adapter arm 254 comprises a supporting contour 256, which is designed to interact with the upper adapter arm 252 during the insertion of the first covering end 214 and to make the covering element 210 form an arch.

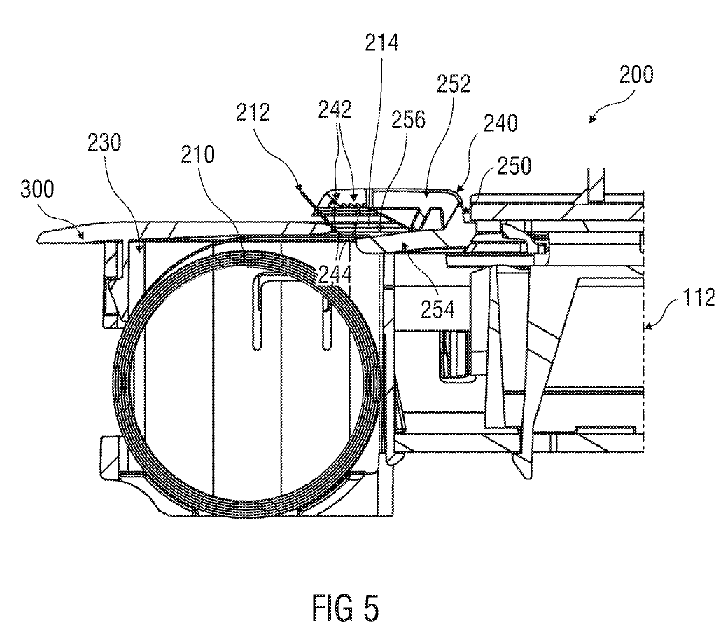

FIG. 5 shows a longitudinal section through a segment of the covering device 200 in a first assembly position of the second rail 116, wherein the second rail 116 has been adjusted in the direction of the covering element 210. The second rail 116 (top rail) is adjusted using the adapter 240, e.g. in the form of a plastic clip, in the direction of an end position. Upon contact and after contact of the first counter latching element 212 with the upper adapter arm 252 of the adapter 240, the first counter latching element 212, e.g. in the form of a tab, is pushed elastically downward.

The adapter 240 is configured to compensate length tolerances during assembly.

The adapter 240 is configured to connect one rail end of the second rail 116 and a free first covering end 214 of the covering element 210 to one another via at least one latching connection 400, irrespective of length tolerances.

The adapter 240 comprises a plurality of first latching elements 242, which are spaced apart from one another in a longitudinal extent of the adapter 240. The respective first latching element 242 can be designed as a latching tooth and/or latching step.

The covering element 210 has at its free first covering end 214 at least one first counter latching element 212, which is guided at least partially out of the rail opening 118 and projects upward in an initial state.

The first counter latching element 212 of the covering element 210 can be of elastically movable design. The first counter latching element 212 can be of flexible design. The first counter latching element 212 can be designed as a latching tongue or latching tab which projects or is raised, in particular punched out, at the first covering end 214. The first counter latching element 212 can be raised by being punched out of a surface of the free first covering end 214, for example.

During assembly, the first counter latching element 212 can be moved, in particular pressed, downward counter to its spring force and/or prestress. During longitudinal adjustment of the second rail 116 into one of its end positions, the adapter 240 comes into contact with the first counter latching element 212 and can press this downward counter to its spring force and/or prestress. The adapter 240 can "override" the covering end 214 having the first counter latching element 212.

By virtue of its spring force, the first counter latching element 212 can rise again and latch in the respective latching gap 244.

FIG. 6 shows a longitudinal section through a segment of the covering device 200 in a second assembly position, e.g. in a final assembled state 132.

When it reaches an end position of the second rail 116, the first counter latching element 212 can latch on a first latching element 242 of the adapter 240 in a self-acting way. By virtue of its spring force, the first counter latching element 212 can be designed as a tab and/or tongue that can be latched in a self-acting way.

In order to produce a connection between the first counter latching element 212 and the adapter 240, whatever the tolerances, the adapter 240 has a stepped latching contour 248.

FIG. 7 shows a longitudinal section through a segment of a rail assembly 112 with a mounted covering device 200.

After the docking of the covering element 210 on the adapter 240, the top rail 116 can be adjusted in the longitudinal direction x. The covering element 210, designed as a rolling spring, is pulled out in order to cover the spindle 120.

The adapter 240 is designed for automatic coupling of the covering element 210 to the second rail 116 during adjustment of the second rail 116 into the end positions of the adjustment range thereof.

Owing to the adjustment of the movable second rail 116 relative to the first rail 114 and away from the cassette 230 in the longitudinal direction x in accordance with arrow 142, the covering element 210 has been rolled out or unrolled.

During the adjustment of the second rail 116 relative to the first rail 114, the covering element 210 is pulled out and covers the rail opening 118 in the first rail 114, ensuring that a spindle 120 is arranged in a protected manner and is not visible.

FIG. 8 shows an enlarged detail of the mounted covering device 200 according to a first exemplary embodiment according to the invention.

The second rail 116 (seat rail) can be adjusted as far as the nominal end position. Here, the first counter latching element 212 (tab or tongue) can latch in the central region of the latching contour 248, which extends in the longitudinal direction x and is, in particular, of stepped design, and/or can latch between central first latching elements 242.

The seat rail can be adjusted as far as the maximum end position (on account of tolerances). The first counter latching element 212, in particular the tab, can latch in the rear region of the latching contour 248 and/or between rear first latching elements 242, e.g. latching steps.

The seat rail can be adjusted as far as the minimum end position. The first counter latching element 212 can latch in the front region of the latching contour 248 and/or between front first latching elements 242, e.g. latching steps.

Depending on the tolerance of the longitudinal adjustment in the end position for docking of the rolling spring, the end of the tab (counter latching element 212) is situated at a different point on the latching contour 248 formed by the first latching elements 242.

A plurality of first latching elements 242 can form a latching contour 248 with a plurality of latching gaps 244 in the longitudinal direction x. The engagement is greater or less, depending on the tolerances, but in all cases a secure connection, in particular a latching connection 400, occurs. In an assembled state 132, the first counter latching element 212 of the covering element 210 can be latchable or latched in stages, e.g. selectively, on one of the first latching elements 242 of the adapter 240.

In a latching position, the first counter latching element 212 of the covering element 210 can engage behind or below a first latching element 242 of the adapter 240, e.g. a latching tooth and/or a latching step. In the latching position, the first counter latching element 212 of the covering element 210 can be accommodated in a latching gap 244 between two first latching elements 242 or in a latching recess and can latch on a stop surface of the first latching element 242. For fixing, the first counter latching element 212 can be pushed or pressed into the latching gap 244 during assembly, and thus locked in the latching gap 244. A spring force of the first counter latching element 212 ensures that this is held under prestress in the latching gap 244. By means of the latched-in first counter latching element 212, the covering element 210 is fixed on the adapter 240.

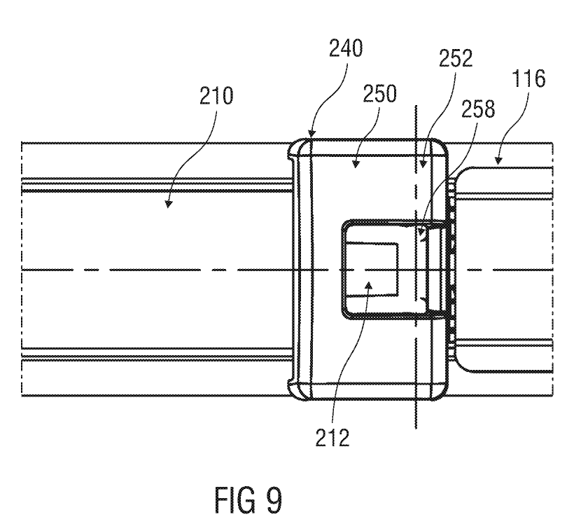

FIG. 9 shows a plan view of a segment of the mounted covering device 200.

In the region of the first latching elements 242, the upper adapter arm 252 can have an engagement opening 258 for the release of the counter latching element 212 of the covering element 210 from its latching position. FIG. 9 shows the engagement opening 258 in the upper adapter arm 252 in the region of the first counter latching element 212 of the covering element 210 for the possible exertion of a force on the first counter latching element 212 in order to release it from the adapter 240.

The adapter 240 can have at least one engagement opening 258 in order to be able to press on the first counter latching element 212 of the covering element 210 for disassembly. The latching engagement or latching connection 400 can be released by pressure on the first counter latching element 212. The covering element 210 can roll up again. It is thereby possible to simplify exchange, maintenance and what is referred to as an "end of the line" check. The releasable latching connection 400 also enables the latching between the first counter latching element 212 and the first latching element 242 to be separated easily and quickly in the case of servicing in the vehicle.

Accordingly, the adapter 240 designed as a plastic clip comprises an engagement opening 258 to enable pressure to be exerted on the tab of the rolling spring for removal. Pressing on the tab releases the latching engagement, and the rolling spring rolls itself up again. This is necessary, for example, for an "end of line" check but also in the case of servicing in the vehicle.

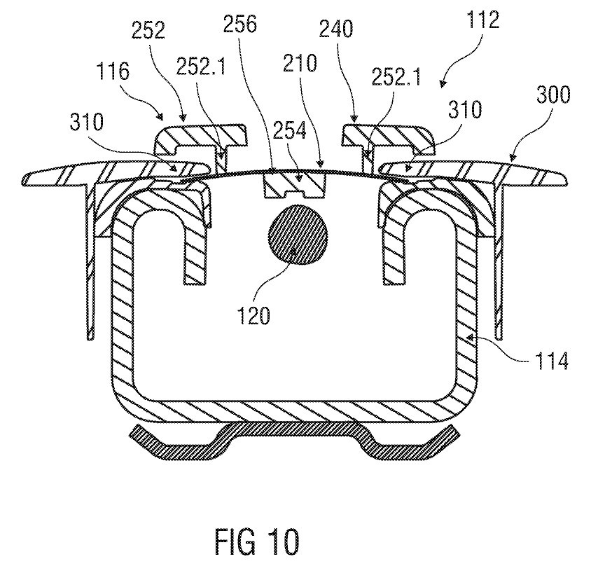

FIG. 10 shows a cross section through a rail assembly 112 with a mounted covering device 200.

The first rail 114 can be a floor rail that can be recessed into a vehicle floor. The first rail 114 can be a rail that is extended relative to the second rail 116. The first rail 114 can have a base portion. The first rail 114 can have two legs projecting on opposite sides of the base portion. The first rail 114 can have end portions bent back inward at the leg ends remote from the base portion. The first rail 114 can have a substantially U-shaped cross section.

The longitudinal adjuster 110 can have a spindle drive, arranged between the first rail 114 and the second rail 116, for moving the second rail 116 relative to the first rail 114. The spindle drive can have a spindle 120. The spindle 120 can have an external thread. The spindle drive can have a gear mechanism drivable by means of a motor. The gear mechanism can be held in the second rail 116.

The bezel 300 can be provided with an integrated, in particular integrally molded, guide channel 310 or a separate guide channel 310. The guide channel 310 may be formed only laterally, in particular on opposite longitudinal sides, of the bezel 300.

The guide channel 310 serves to guide the covering element 210 during the adjustment of the vehicle seat 100. The guide channel 310 lies above or on the first rail 114.

The covering element 210 has an outer edge portion. In this case, the lateral edge portions of the covering element 210 are guided, for example, by means of the lateral guide channels 310 of the bezel 300 as the covering element 210 is rolled up or unrolled.

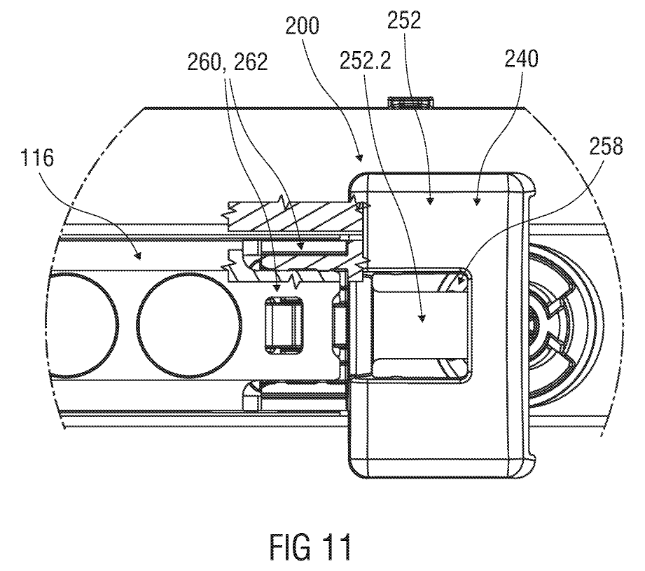

On an inner side facing the first counter latching element 212 of the covering element 210, a lower adapter arm 254 can have a supporting contour 256, in particular an outer contour slightly bent in the transverse direction y, which is designed to interact with the upper adapter arm 254 during the insertion of the covering element 210 between the adapter arms 252, 254 and to make the covering element 210 form an arch, in particular a transverse arch. For this purpose, the upper adapter arm 252 can have two downwardly projecting arm supports 252.1 at the edges of the arms. The upper adapter arm 252 can have a long nose 252.2 (visible in FIG. 11) arranged in the center between the arm supports 252.1 and having the first latching elements 242. The nose 252.2 is so long and wide that an opening in the region of the punched-out first counter latching element 212 on the covering element 210 is covered.

The free first covering end 214 of the covering element 210, which is designed as a rolling spring for example, can be of flat design in the transverse direction y. As the covering element 210 is pulled out, a region adjacent to the free first covering end 214, which was previously in the rolled-up state, has a transverse arch. In the case of rolling springs, this may be due to the design thereof. The covering element 210, which, before the installation of the second rail 116, is arranged rolled up in the covering device 200, can have a continuous arched surface. In the region of the transition from the straight first covering end 214 to the rolled-up or wound-up region, waviness may occur. This waviness can increase friction in a guide channel 310 of the bezel 300 for guiding the covering element 210 during rail adjustment. As the rolling spring is inserted into the adapter 240, the first covering end 214 of the rolling spring may be arched in the transverse direction in order to match the transition to the transverse arch of the remainder of the rolling spring. It is thereby possible to reduce the waviness in the region of the transition. The friction in the guide channel 310 can be correspondingly reduced.

Thus, the end of the rolling spring is arched during the docking of the adapter 240 on the rolling spring.

FIG. 11 shows a plan view of a segment of a second rail 116 of a rail assembly 112 before the installation of an adapter 240 of a covering device 200.

The adapter 240 can be designed as a plastic adapter and/or plastic clip. The adapter 240 can be detachably or non-detachably connectable or connected to the second rail 116. In the exemplary embodiment shown, the adapter 240 is releasably connectable to the second rail 116, e.g. via corresponding clip elements 260, 262 and/or latching geometries. The plastic clip is clipped to the top rail (116), for example.

The use of a plastic adapter, in particular a plastic clip, avoids creaking noises in the interface. An adapter 240 formed from plastic has the advantage that troublesome noises, such as creaking noises and/or scratching noises, can be reduced or even avoided during the operation of a rail assembly 112. The adapter 240 can be an injection molding, for example. The adapter 240 comprises an adapter body 250, into which a plurality of first latching elements 242 is integrated.

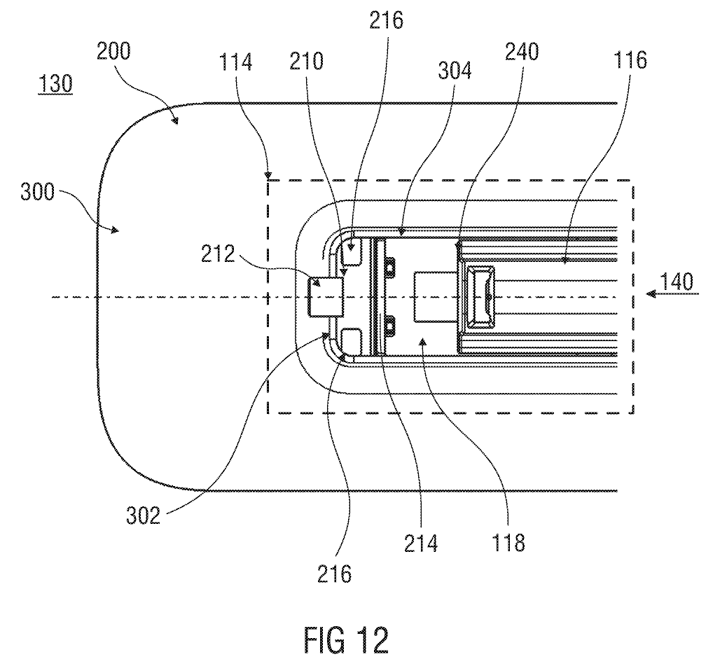

FIG. 12 shows a plan view of a segment of a covering device 200 according to a second exemplary embodiment according to the invention. The functioning and mode of action of the covering device 200 according to the second exemplary embodiment is similar to the covering device 200 according to the first exemplary embodiment. The rail assembly 112 is of similar configuration to the rail assembly 112 according to the previous description.

The adapter 240 is designed for automatic coupling of the covering element 210 to the second rail 116 during adjustment of the second rail 116 into the end positions of the adjustment range thereof.

The covering device 200 comprises at least one covering element 210, which covers a region of a rail opening 118 in the first rail 114 which is not covered by the second rail 116. For this purpose, the covering element 210 is designed as a roll-up element in order to cover the first rail 114, in particular the rail opening 118 thereof, in a correspondingly variable manner during a movement of the second rail 116 relative to the first rail 114.

In particular, FIG. 12 shows the covering element 210, e.g. in the form of a rolling spring, having at least one first counter latching element 212, e.g. in the form of a raised and punched-out tab and/or tongue, in a delivery position 130. The first counter latching element 212 is supported on an upper side of a bezel edge 302 of a bezel 300. In a delivery position 130, the raised first counter latching element 212 can be guided out of a bezel opening 304 of the bezel 300 for simplified docking. For example, the first counter latching element 212 can engage around the bezel 300 at a bezel edge 302 of the bezel opening 304 in an initial state and/or a delivery position 130. In this state and/or this position, floor attachment regions can be accessible for a person in order to screw the first rail 114 to a vehicle floor.

The first rail 114, in particular a lower rail, comprises a bezel 300 in the direction of the second rail 116. The bezel 300 is designed as a bezel frame which runs around the, in particular elongate or slotted, rail opening 118 in the first rail 114. The bezel 300 lies above or on the first rail 114. As a result, the bezel 300 is supported on the first rail 114. In addition, the bezel 300 can also cover side regions of the first rail 114.

The bezel 300 can be a plastic element, in particular a plastic bezel. In particular, the first rail 114 is designed as a profile component, in particular a metal profile component.

To cover the rail opening 118 and the bezel opening 304, the covering device 200 comprises the covering element 210, which is shown in the unrolled state in FIG. 7 and thus in a state in which it covers the rail opening 118 and the bezel opening 304. The bezel 300 can have an outwardly projecting collar region for covering the vehicle floor, e.g. for clamping and/or holding down a carpet.

An embodiment without a bezel is also possible.

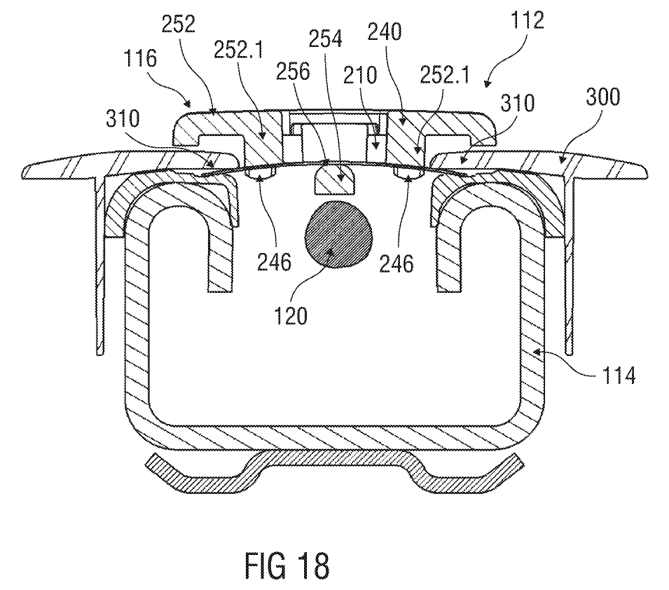

At least the rail opening 118 can be partially closable by means of the covering element 210 guided in the bezel 300. By means of the at least partial covering of the rail opening 118 by means of the covering element 210, it is possible, for example, to block the view of a spindle 120 (illustrated in FIGS. 8 and 18), arranged within a first rail 114, of an electric adjustment system.

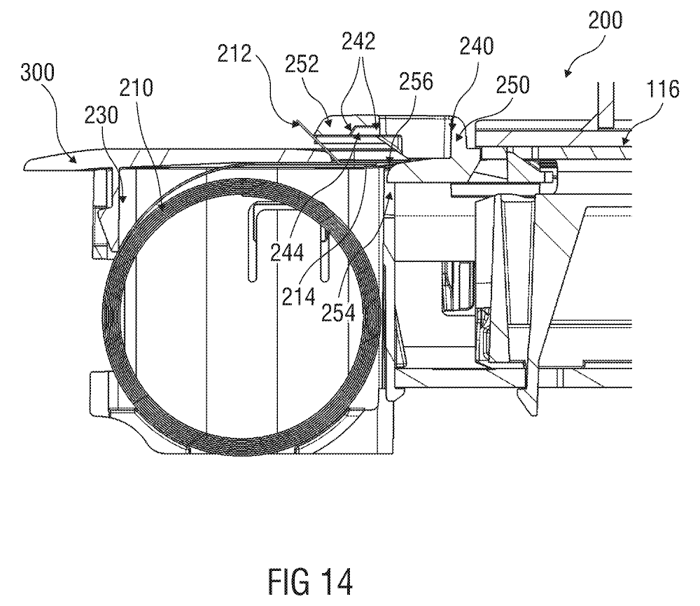

At its rear end, the covering device 200 can have a first cassette 230 (shown in FIG. 14). At a front end, the covering device 200 can have a second cassette 230. The covering device 200 preferably has a first cassette 230 at a rear end and a second cassette 230 at a front end. The covering element 210 for covering a first region in front of the second rail 116 (in the longitudinal direction x) can be provided in the first cassette 230. A second covering element 210 for covering a second region behind the second rail 116 (in the longitudinal direction x) can be provided in the second cassette 230. The covering element 210 can be rolled up in the respective cassette 230.

The covering element 210 can be of spring-elastic design. The covering element 210 can be a constant force spring, in particular a rolling spring. A first end of the covering element 210 can be connected to a second rail 116. A second end of the covering element 210 can be arranged in a captive manner in the cassette 230 assigned to the covering element 210 or in a housing. In particular, the covering element 210 is supported in a captive manner in the cassette 230 in the rolled-up state and when being unrolled or rolled up. For this purpose, the covering element 210 has a length, and/or the cassette 230 has a shape and/or dimensions, at least on the inside, such that the covering element 210 can be arranged in the cassette 230 when rolled up and, while the free first end of the covering element 210 is being subjected to a force, in particular a pulling force, for unrolling, or while the covering element 210 is being subjected to a force, in particular a restoring force, for rolling up the covering element 210 again, this element is arranged, in particular supported, in a captive manner in the cassette 230.

The covering device 200 furthermore comprises an adapter 240 arranged on the second rail 116. The adapter 240 is arranged between the second rail 116 and the covering element 210 and is configured to compensate length tolerances during assembly.

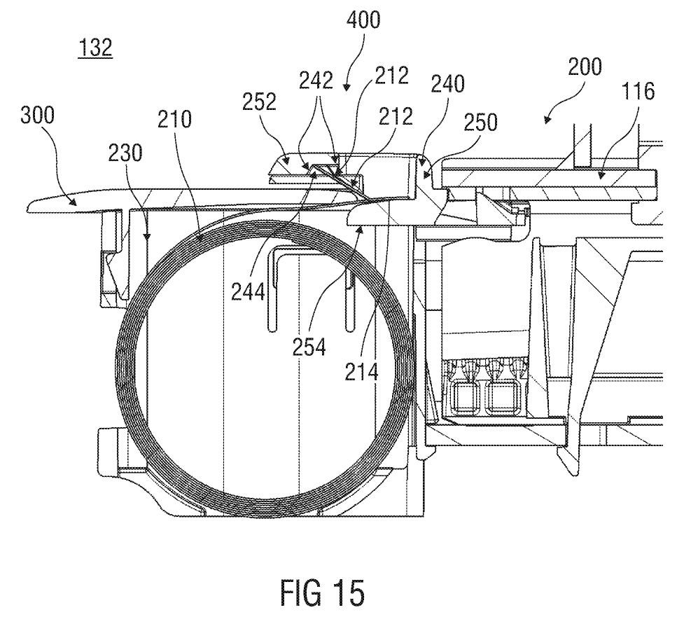

The adapter 240 is configured to connect one rail end of the second rail 116 facing the covering element 210 and a free first covering end 214 of the covering element 210 to one another via at least one first latching connection 400 (in FIG. 15), irrespective of length tolerances.

The covering element 210 comprises at least one second counter latching element 216. In the exemplary embodiment illustrated, the covering element 210 comprises a first counter latching element 212 designed as a latching tab and/or latching tongue, and two second counter latching elements 216. In the longitudinal extent, the second counter latching elements 216 can be arranged in a region on the free first covering end 214 which faces the adapter 240. The second counter latching elements 216 are each designed as latching openings, e.g. rectangular, round or oval holes, in particular punched holes.

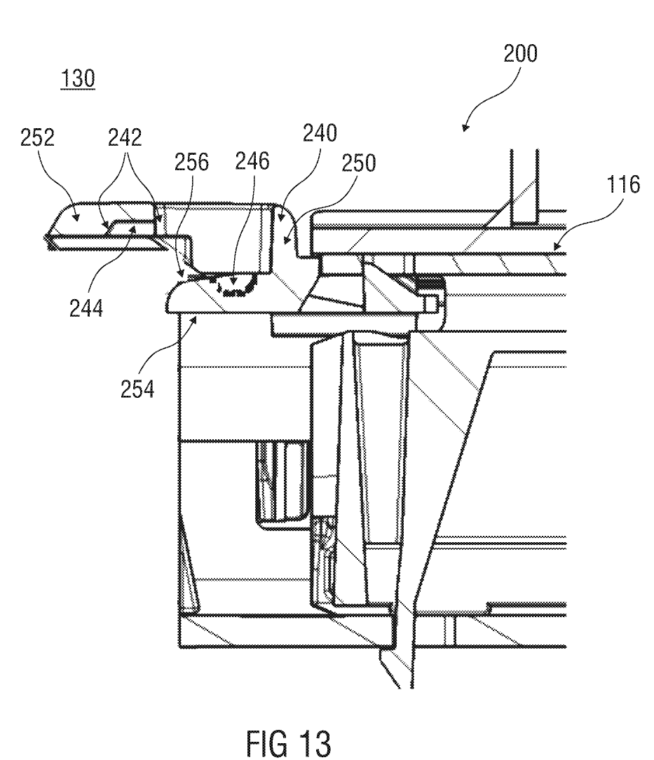

FIG. 13 shows a longitudinal section through a segment of the covering device 200 in the region of an adapter 240 for connecting the covering element 210 to the second rail 116.

The adapter 240 comprises a first latching element 242, which forms a latching gap 244, e.g. a latching receptacle, by means of a spaced offset (in the longitudinal direction x). The adapter 240 can also have two first latching elements 242, e.g. latching steps, spaced apart in the longitudinal direction x. An elongate latching gap 244 can be formed between two mutually spaced first latching elements 242.

The adapter 240 can have at least one second latching element 246. The second latching element 246 can be designed as a latching knob and/or latching pin.

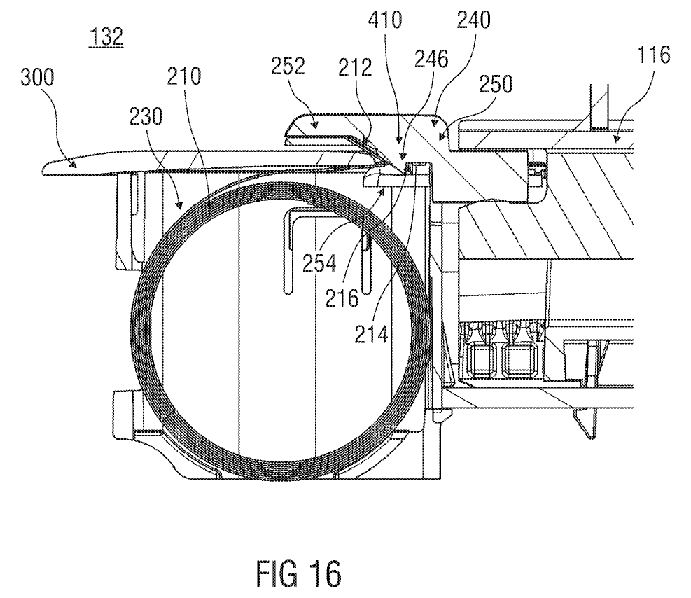

When the longitudinal adjuster is adjusted into the end position for the first time, the adapter 240 comes into engagement with the covering element 210. The adjustment travel differs on account of the tolerances in the system. This can comprise a tolerance field of 3 mm, for example. In order to produce a secure connection between the first counter latching element 212 of the covering element 210 and the adapter 240, whatever the tolerances, the adapter 240 comprises a latching gap 244 provided for the first counter latching element 212, as well as two second latching elements 246. In an assembled state 132, the second latching elements 246 engage in the two second counter latching elements 216 of the covering element 210. It is thereby possible to produce a second latching connection 410 (shown in FIG. 16). A first latching connection 400 (shown in FIG. 15) can be effected by the engagement of the first counter latching element 212 of the covering element 210 on the first latching element 242 in the latching gap 244 of the adapter 240. Depending on the tolerance, the first counter latching element 212, which is designed as a spring tab, is over-bent or has a slight play. Moreover, in each case, the two second latching elements 246, which are designed as knobs for example, engage in the second counter latching elements 216, which are designed as punched holes for example. In all cases, however, a secure connection, in particular a latching connection 400, 410, takes place.

The adapter 240 comprises an adapter body 250 and at least two adapter arms 252, 254 arranged on the adapter body 250 and oriented in the vertical direction z relative to one another or spaced apart, wherein the covering element 210 is arranged partially between the adapter arms 252, 254 in an assembled state 132.

The free first covering end 214, which has the first counter latching element 212 and the second counter latching elements 216, can be accommodated, e.g. clamped, between the adapter arms 252, 254 when the first counter latching element 212 is latched on a first latching element 242 of the adapter 240.

The upper adapter arm 252 comprises first latching elements 242 and the latching gap 244 on an inner side facing the first counter latching element 212 of the covering element 210. The upper adapter arm 252 comprises two second latching elements 246, e.g. latching knobs, spaced apart in the transverse direction y on an inner side facing the second counter latching element 216 of the covering element 210.

On an inner side facing the first counter latching element 212 of the covering element, the lower adapter arm 254 comprises a supporting contour 256, which is designed to interact with the upper adapter arm 252 during the insertion of the first covering end 214 and to make the covering element 210 form an arch.

FIG. 14 shows a longitudinal section through a segment of the covering device 200 in a first assembly position.

The top rail 116 is adjusted using the adapter 240, e.g. in the form of a plastic clip, in the direction of an end position. Upon contact and after contact of the first counter latching element 212 with the upper adapter arm 252 of the adapter 240, the first counter latching element 212, e.g. in the form of a tab, is pushed elastically downward.

The adapter 240 is configured to compensate length tolerances during assembly.

The adapter 240 is configured to connect one rail end of the second rail 116 and a free first covering end 214 of the covering element 210 to one another via at least one latching connection 400, 410, irrespective of length tolerances.

The adapter 240 comprises two latching elements 242, which are spaced apart from one another in a longitudinal extent of the adapter 240. The respective first latching element 242 can be designed as a latching tooth and/or latching step. A latching gap 244 or latching recess is formed between the first latching elements 242.

The covering element 210 has at its free first covering end 214 at least one first counter latching element 212, which is guided at least partially out of the rail opening 118 and projects upward in an initial state.

The first counter latching element 212 of the covering element 210 can be of elastically movable design. The first counter latching element 212 can be of flexible design. The first counter latching element 212 can be designed as a latching tongue or latching tab which projects or is raised, in particular punched out, at the first covering end 214. The first counter latching element 212 can be raised by being punched out of a surface of the free first covering end 214, for example.

During assembly, the first counter latching element 212 can be moved, in particular pressed, downward counter to its spring force and/or prestress. During longitudinal adjustment of the second rail 116 into one of its end positions, the adapter 240 comes into contact with the first counter latching element 212 and can press this downward counter to its spring force and/or prestress. The adapter can "override" the covering end 214 having the first counter latching element 212.

FIG. 15 shows a longitudinal section through a segment of the covering device 200 in a second assembly position, e.g. in an assembled state 132.

The second rail 116 can be adjusted as far as a nominal end position. The first counter latching element 212, designed as a tab, of the covering element 210 can latch in the region of the first latching element 242 provided for this purpose and within the latching gap 244.

The second rail 116 can be adjusted as far as a minimum (front) end position, wherein the tab can latch in the rear region of the latching gap 244. During this process, the tab comes into contact with the rail contour of the latching step of the adapter 240.

The second rail 116 can be adjusted as far as a maximum (rear) end position. The tab can latch in a front region in the latching gap 244 - provided for this purpose - with the required play to ensure an overtravel for tolerance compensation. Likewise, the latching knobs in the rear region latch into the, for example rectangular, punched holes provided for this purpose in the rolling spring and thus ensure a secure connection.

For fixing, the first counter latching element 212 can be pushed or pressed into the latching gap 244 during assembly, and thus locked in the latching gap 244. A spring force of the first counter latching element 212 ensures that this is held under prestress in the latching gap 244. By means of the latched-in first counter latching element 212, the covering element 210 is fixed on the adapter 240.

For additional fixing, the second latching element 246 is pushed or pressed into the second counter latching element 216 during assembly, and is thus locked in the second counter latching element 216. By means of the latched-in second latching element 246, the covering element 210 is fixed on the adapter 240.

FIG. 16 shows another longitudinal section through a segment of the covering device 200 in the second assembly position, e.g. in the assembled state 132, shown in FIG. 15.

The second latching elements 246, in particular latching knobs, of the adapter 240 hook in on both sides (in the transverse direction y) into the second counter latching elements 216, in particular punched holes - provided for this purpose - of the covering element 210.

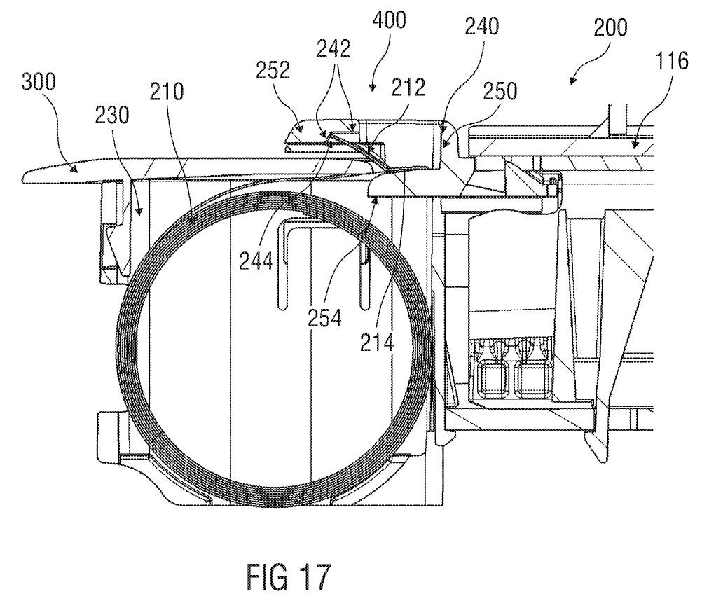

FIG. 17 shows a longitudinal section through a segment of the covering device 200 in a third assembly position.

Depending on the tolerance of the longitudinal adjustment into the end position for "docking" the covering element 210 or rolling spring, the end of the first counter latching element 212 or tab is situated either with less or more play in the latching gap 244 on the matching first latching element 242 of the adapter 240. As a result of the adjustment of the second rail 116, the first counter latching element 212 or tab is somewhat over-bent and/or the second latching elements 246 or latching knobs of the adapter 240 enter into latching engagement with the second counter latching elements 216 or latching openings in the covering element 210.

FIG. 18 shows a cross section through a rail assembly 112 with a mounted covering device 200.

The first rail 114 can be a floor rail that can be recessed into a vehicle floor. The first rail 114 can be a rail that is extended relative to the second rail 116. The first rail 114 can have a base portion. The first rail 114 can have two legs projecting on opposite sides of the base portion. The first rail 114 can have end portions bent back inward at the leg ends remote from the base portion. The first rail 114 can have a substantially U-shaped cross section.

The longitudinal adjuster 110 can have a spindle drive, arranged between the first rail 114 and the second rail 116, for moving the second rail 116 relative to the first rail 114. The spindle drive can have a spindle 120. The spindle 120 can have an external thread. The spindle drive can have a gear mechanism drivable by means of a motor. The gear mechanism can be held in the second rail 116.

The bezel 300 can be provided with an integrated, in particular integrally molded, guide channel 310 or a separate guide channel 310. The guide channel 310 may be formed only laterally, in particular on opposite longitudinal sides, of the bezel 300.

The guide channel 310 serves to guide the covering element 210 during the adjustment of the vehicle seat 100. The guide channel 310 lies above or on the first rail 114.

The covering element 210 has an outer edge portion. In this case, the lateral edge portions of the covering element 210 are guided, for example, by means of the lateral guide channels 310 of the bezel 300 as the covering element 210 is rolled up or unrolled.

On an inner side facing the first counter latching element 212 of the covering element 210, a lower adapter arm 254 can have a supporting contour 256, in particular an outer contour slightly bent in the transverse direction y, which is designed to interact with the upper adapter arm 254 during the insertion of the covering element 210 between the adapter arms 252, 254 and to make the covering element 210 form an arch, in particular a transverse arch. For this purpose, the upper adapter arm 252 can have two downwardly projecting arm supports 252.1 at the edges of the arms. The upper adapter arm 252 can have a long nose 252.2 (visible in FIG. 11) arranged in the center between the arm supports 252.1 and having the first latching elements 242. The nose 252.2 is so long and wide that an opening in the region of the punched-out first counter latching element 212 on the covering element 210 is covered.

The free first covering end 214 of the covering element 210, which is designed as a rolling spring for example, can be of flat design in the transverse direction y. As the covering element 210 is pulled out, a region adjacent to the free first covering end 214, which was previously in the rolled-up state, has a transverse arch. In the case of rolling springs, this may be due to the design thereof. The covering element 210, which, before the installation of the second rail 116, is arranged rolled up in the covering device 200, can have a continuous arched surface. In the region of the transition from the straight first covering end 214 to the rolled-up or wound-up region, waviness may occur. This waviness can increase friction in a guide channel 310 of the bezel 300 for guiding the covering element 210 during rail adjustment. As the rolling spring is inserted into the adapter 240, the first covering end 214 of the rolling spring may be arched in the transverse direction y in order to match the transition to the transverse arch of the remainder of the rolling springs. It is thereby possible to reduce the waviness in the region of the transition. The friction in the guide channel 310 can be correspondingly reduced.

Thus, the end of the rolling spring is arched during the docking of the adapter 240 on the rolling spring.

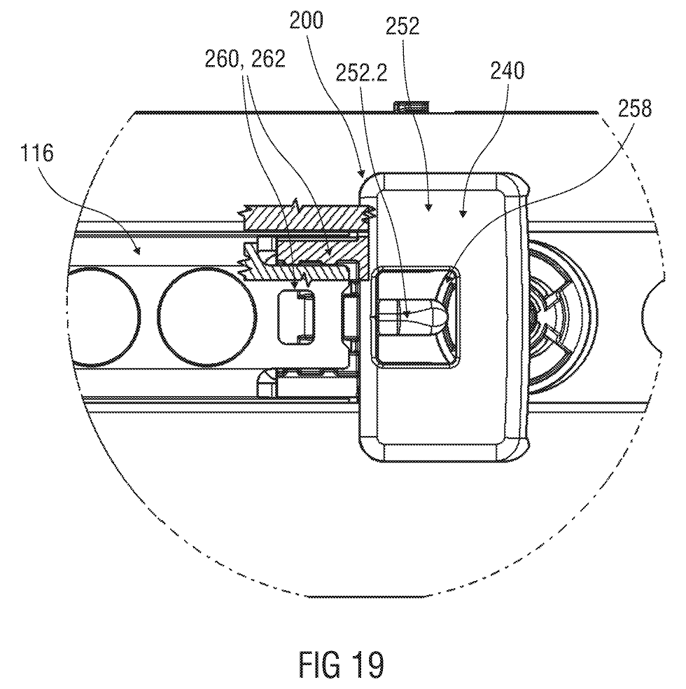

FIG. 19 shows a plan view of a segment of a second rail 116 of a rail assembly 112 before the installation of an adapter 240 of a covering device 200.

The adapter 240 can be designed as a plastic adapter and/or plastic clip. The adapter 240 can be detachably or non-detachably connectable or connected to the second rail 116. In the exemplary embodiment shown, the adapter 240 is releasably connectable to the second rail 116, e.g. via corresponding clip elements 260, 262 and/or latching geometries. The plastic clip is clipped to the top rail 116, for example.

The use of a plastic adapter, in particular a plastic clip, avoids creaking noises in the interface. An adapter 240 formed from plastic has the advantage that troublesome noises, such as creaking noises and/or scratching noises, can be reduced or even avoided during the operation of a rail assembly 112. The adapter 240 can be an injection molding, for example. The adapter 240 comprises an adapter body 250, into which a plurality of first latching elements 242 is integrated.

The adapter 240 designed as a plastic clip comprises an engagement opening 258 to enable pressure to be exerted on the first counter latching element 212 or the tab of the covering element 210 for removal. In the first step, a wedge-shaped slide can be guided from behind between the covering element 210 or rolling spring and the adapter 240 in order to disengage the second latching elements 246 or knobs of the adapter 240 and the second counter latching elements 216 or latching openings. In the next step, the engagement with the latch can be released by pressure on the tab. The covering element 210 can roll up again. This is necessary, for example, for an "end of line" check but also in the case of servicing in the vehicle.

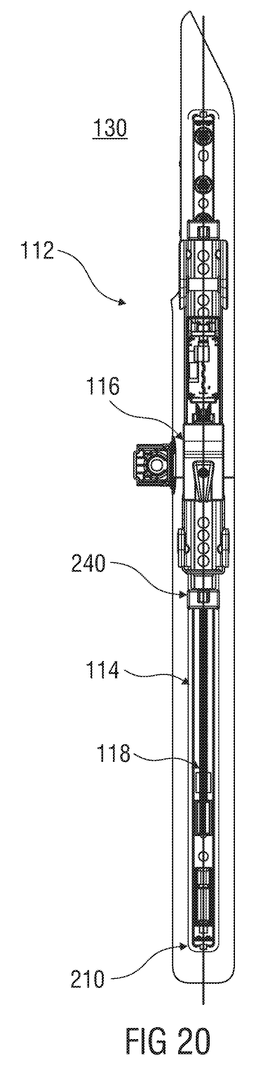

FIG. 20 shows a plan view of a rail assembly 112 arranged on a vehicle floor and comprising a fixed rail 114, a movable rail 116, which has been adjusted to a forward longitudinal position, and a pre-installed covering device 200, wherein a rail opening 118 for screwing the fixed rail 114 to the vehicle floor is disclosed.

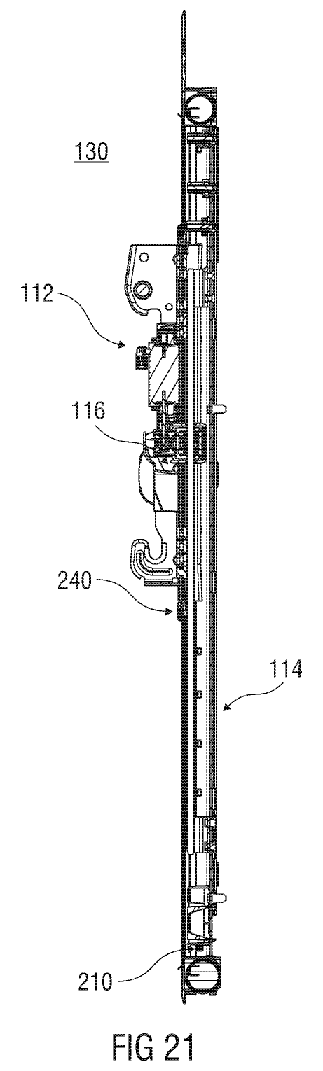

FIG. 21 shows a longitudinal section through the rail assembly 112 according to FIG. 20.

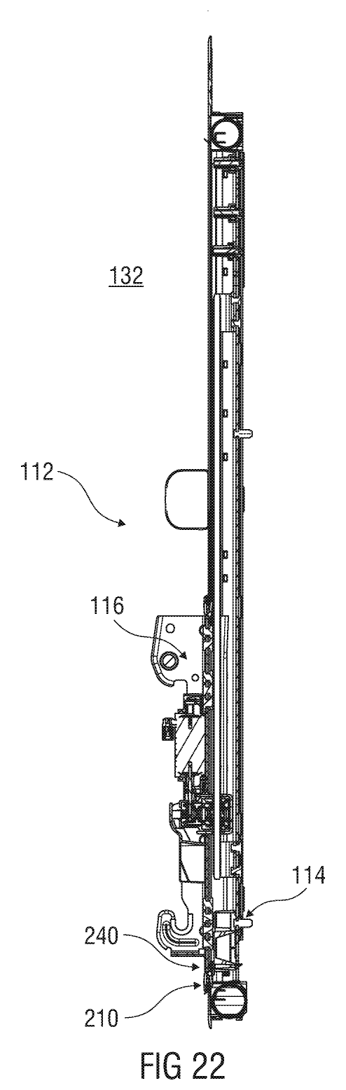

FIG. 22 shows a longitudinal section through the rail assembly 112, wherein the movable rail 116 has been adjusted to one of its end positions for connecting an adapter 240 to a covering element 210 of the covering device 200.

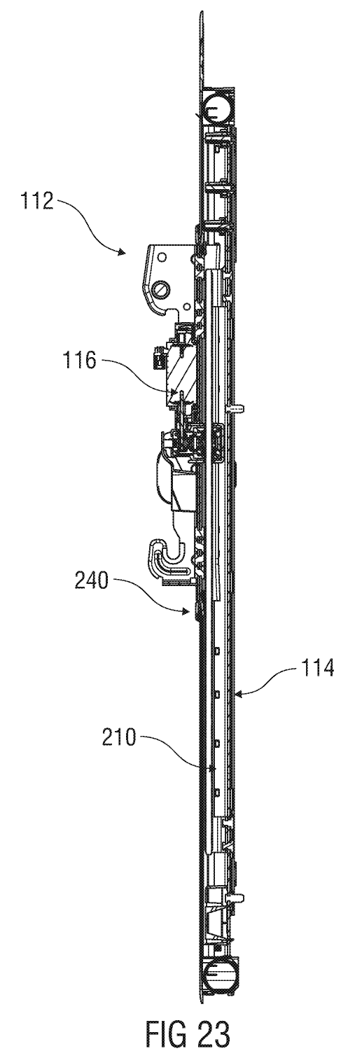

FIG. 23 shows a longitudinal section through the rail assembly 112, wherein, after the connection of the adapter 240 to the covering element 210 of the covering device 200, the movable rail 116 has been adjusted to a forward longitudinal position.

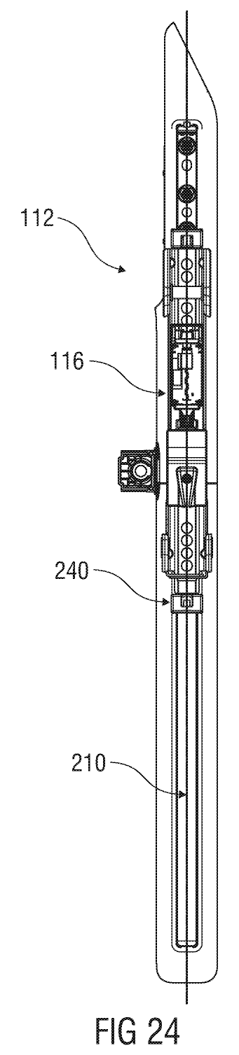

FIG. 24 shows a plan view of the rail assembly 112, wherein a rail opening 118 is covered by the unwound covering element 210 connected to the adapter 240.

### LIST OF REFERENCE SIGNS

100 vehicle seat
102 seat part
104 seat back
106 fitting
108 axis of rotation
110 longitudinal adjuster
112 rail assembly
114 first rail (bottom rail)
116 second rail (top rail)
118 rail opening
120 spindle
130 delivery position
132 assembled state
140 arrow
142 arrow
200 covering device
210 covering element
212 first counter latching element
214 first covering end
216 second counter latching element
230 cassette
240 adapter
242 first latching element
244 latching gap
246 second latching element
248 latching contour
250 adapter body
252 adapter arm
252.1 arm support
252.2 nose
254 adapter arm
256 supporting contour
258 engagement opening
260, 262 clip element
300 bezel
302 bezel edge
304 bezel opening
310 guide channel
400, 410 latching connection
x longitudinal direction
y transverse direction
z vertical direction
102 seat part

What is claimed is:

1. A rail assembly for a longitudinal adjuster of a vehicle seat, the rail assembly, comprising:
one first rail,
one second rail, which is arranged movably relative to the first rail, and- one covering device for covering a rail opening in the first rail,- wherein the covering device comprises at least one covering element, which is arranged at one rail end of the first rail in such a way that it can be rolled up, and one adapter, which is arranged between the second rail and the covering element and is configured to compensate length tolerances during assembly.

2. The rail assembly as claimed in claim 1,
wherein the adapter is configured to connect one rail end of the second rail and a free first covering end of the covering element to one another via at least one latching connection, irrespective of length tolerances.

3. The rail assembly as claimed in claim 1,
wherein the adapter has a first latching element or has a plurality of first latching elements, which are spaced apart from one another in a longitudinal extent of the adapter.

4. The rail assembly as claimed in claim 3,
wherein the respective first latching element is designed as a latching tooth and/or latching step.

5. The rail assembly as claimed in claim 1,
wherein the adapter has at least one second latching element, which is designed as a latching knob.

6. The rail assembly as claimed in claim 1,
wherein the covering element has at its free first covering end at least one first counter latching element, which is guided at least partially out of the rail opening and projects upward in a delivery position.

7. The rail assembly as claimed in claim 6,
wherein the first counter latching element is of elastically movable design.

8. The rail assembly as claimed in claim 6,
wherein the first counter latching element is designed as a tab or tongue which projects and is raised at a free first covering end.

9. The rail assembly as claimed in claim 1,
wherein the covering element has at its free first covering end at least one second counter latching element, which is designed as a latching opening.

10. The rail assembly as claimed in claim 1,
wherein the adapter has an adapter body and at least two adapter arms arranged on the adapter body and oriented in a vertical direction relative to one another, wherein the covering element is arranged partially between the adapter arms in an assembled state.

11. The rail assembly as claimed in claim 10,
wherein an upper adapter arm has the first and/or second latching elements on an inner side facing the first counter latching element of the covering element.

12. The rail assembly as claimed in claim 11,
wherein, in the region of the first and/or second latching elements, the upper adapter arm has an engagement opening for the release of the counter latching element of the covering element from its latching position.

13. The rail assembly as claimed in claim 10,
wherein, on an inner side facing the first counter latching element of the covering element, a lower adapter arm has a supporting contour, which is designed to interact with the upper adapter arm during the insertion of the covering element and to make the covering element form an arch.

14. The rail assembly as claimed in claim 1,
wherein the adapter is designed as a plastic adapter and/or plastic clip which is detachably or non-detachably connectable or connected to the second rail.
